(19) United States
(12) Patent Application Publication
(10) Pub. No.: US 2026/0049441 A1
(43) Pub. Date: Feb. 19, 2026

(54) LAUNDRY APPLIANCE DOOR LOCK ASSEMBLY

(71) Applicant: Haier US Appliance Solutions, Inc., Wilmington, DE (US)

(72) Inventors: Tanner Davis Gunn, Louisville, KY (US); Christopher Gene Vowels, Cox’s Creek, KY (US)

(21) Appl. No.: 18/802,139

(22) Filed: Aug. 13, 2024

(51) Int. Cl. D06F 39/14; D06F 58/20; E05B 63/00

(52) U.S. Cl. CPC D06F 39/14; D06F 58/20; E05B 63/0052; E05Y 2900/312

(57) ABSTRACT

A laundry appliance includes a cabinet including a panel, a basket rotatably mounted within the cabinet and defining a chamber for receiving of a load of clothes, a door rotatably mounted to the cabinet to provide selective access to the chamber, and a door lock assembly. The door lock assembly is mounted to the panel for selectively locking the door and includes a door lock frame defining first and second positioning features that extend from the door lock frame. The panel of the cabinet defines first and second positioning features apertures. The first positioning feature aperture is configured to receive the first positioning feature and the second positioning feature aperture is elongated in a lateral, vertical, or transverse direction and configured to receive the second positioning feature.

### FIELD OF THE INVENTION

The present subject matter relates generally to laundry appliances, or more specifically, to door lock assemblies of laundry appliances.

### BACKGROUND OF THE INVENTION

Washing machine appliances generally include a tub for containing water or wash fluid, e.g., water and detergent, bleach, and/or other wash additives. A basket is rotatably mounted within the tub and defines a wash chamber for receipt of articles for washing. During normal operation of such washing machine appliances, the wash fluid is directed into the tub and onto articles within the wash chamber of the basket. The basket or an agitation element can rotate at various speeds to agitate articles within the wash chamber, to wring wash fluid from articles within the wash chamber, etc. During a spin or drain cycle, a drain pump assembly may operate to discharge water from within sump.

Conventional washing machine appliances (or laundry appliances in general) include a door that is pivotally mounted to the cabinet over an opening to provide selective access to the wash chamber and a door lock with a receptacle for receiving the striker of the door when closing the door. However, strikers and door lock receptacles sometimes become misaligned and, thus, make it difficult to close the door. Striker and door lock misalignment may be due to shifting/movement of the door lock or variation in the assembly of the appliance. Previous door lock designs have been developed to constrain or inhibit shifting/movement of the door lock. While such door lock designs work well, further improvements are needed.

Accordingly, a laundry appliance having an improved door lock assembly would be desirable. More specifically, a door lock assembly that provides improved rigidity and receptacle alignment with the door striker would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a laundry appliance defining a vertical direction, a transverse direction, and a lateral direction is provided. The laundry appliance includes a cabinet including a panel and a basket rotatably mounted within the cabinet and defining a chamber for receiving a load of clothes. Additionally, the laundry appliance includes a door rotatably mounted to the cabinet to provide selective access to the chamber and a door lock assembly mounted to the panel for selectively locking the door. The door lock assembly includes a door lock frame defining a first positioning feature and a second positioning feature that extend from the door lock frame. The panel of the cabinet defines a first positioning feature aperture and a second positioning feature aperture. Furthermore, the first positioning feature aperture is configured to receive the first positioning feature and the second positioning feature aperture is elongated in the lateral direction, the vertical direction, or the transverse direction and configured to receive the second positioning feature aperture.

In another exemplary embodiment, a laundry appliance defining vertical direction, a transverse direction, and a lateral direction is provided. The laundry appliance includes a cabinet including a panel and a basket rotatably mounted within the cabinet and defining a chamber for receiving a load of clothes. Additionally, the laundry appliance includes a door rotatably mounted to the cabinet to provide selective access to the chamber and a door lock assembly mounted to the panel for selectively locking the door. The door lock assembly includes a door lock frame defining a first positioning feature and a second positioning feature that extend from the door lock frame. The second positioning feature includes a hook portion. Additionally, the panel of the cabinet defines a first positioning feature aperture and a second positioning feature aperture. The first positioning feature aperture is circular. Moreover, the first positioning feature aperture is configured to receive the first positioning feature and the second positioning feature aperture is configured to receive the second positioning feature.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance according to an example embodiment of the present subject matter.

FIG. 2 provides a front view of the example washing machine appliance of FIG. 1 with a door in an intermediate, e.g., partially open, position according to an example embodiment of the present subject matter.

FIG. 3 provides a side cross-sectional view of the example washing machine appliance of FIG. 1 according to an example embodiment of the present subject matter.

FIG. 4 provides a perspective view of a door lock assembly according to an example embodiment of the present subject matter.

FIG. 5 provides a front view of a front panel of the example washing machine appliance of FIG. 1 according to an example embodiment of the present subject matter.

FIG. 6 provides a perspective view of the example door lock assembly of FIG. 4 mounted to the example front panel of FIG. 5 according to an example embodiment of the present subject matter.

FIG. 7 provides a front view of the example door lock assembly of FIG. 4 mounted to the example front panel of FIG. 5 according to a first example embodiment of the present subject matter.

FIG. 8 provides a front view of the example door lock assembly of FIG. 4 mounted to the example front panel of FIG. 5 according to a second example embodiment of the present subject matter.

FIG. 9 provides a side view of the example door lock assembly of FIG. 4 mounted to the example front panel of FIG. 5 according to an example embodiment of the present subject matter.

FIG. 10 provides a perspective view of a first positioning feature of the example door lock assembly of FIG. 4 protruding through the example front panel of FIG. 5 according to an example embodiment of the present subject matter.

FIG. 11 provides a perspective view of a second positioning feature of the example door lock assembly of FIG. 4 protruding through the example front panel of FIG. 5 according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising. ” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration. ” In addition, references to “an embodiment” or “one embodiment”does not necessarily refer to the same embodiment, although it may.

Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

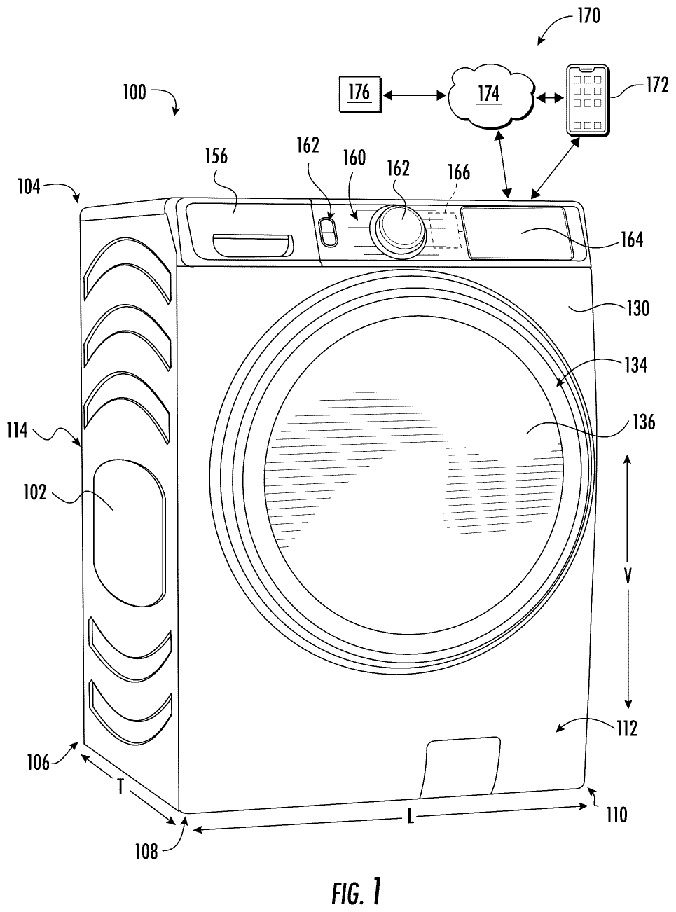

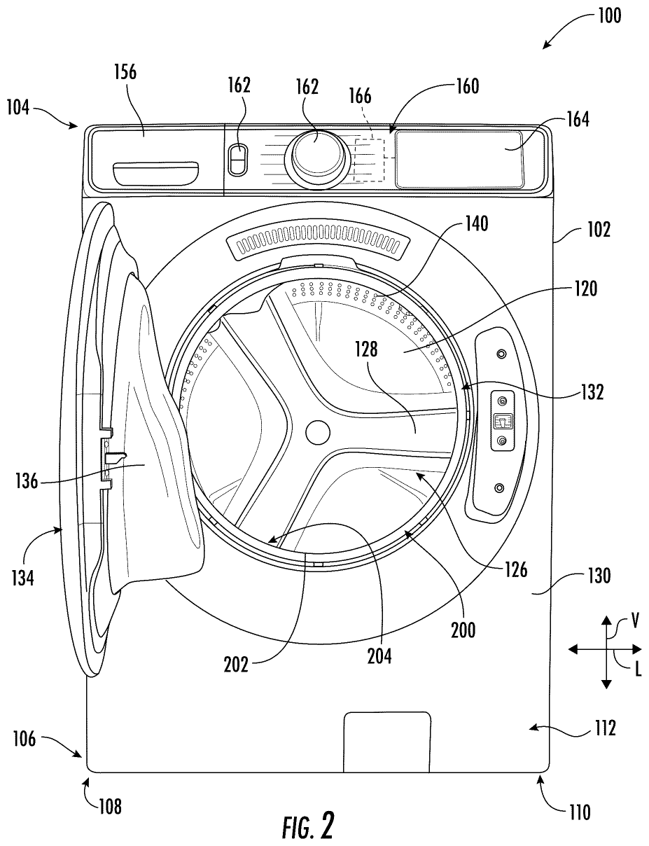

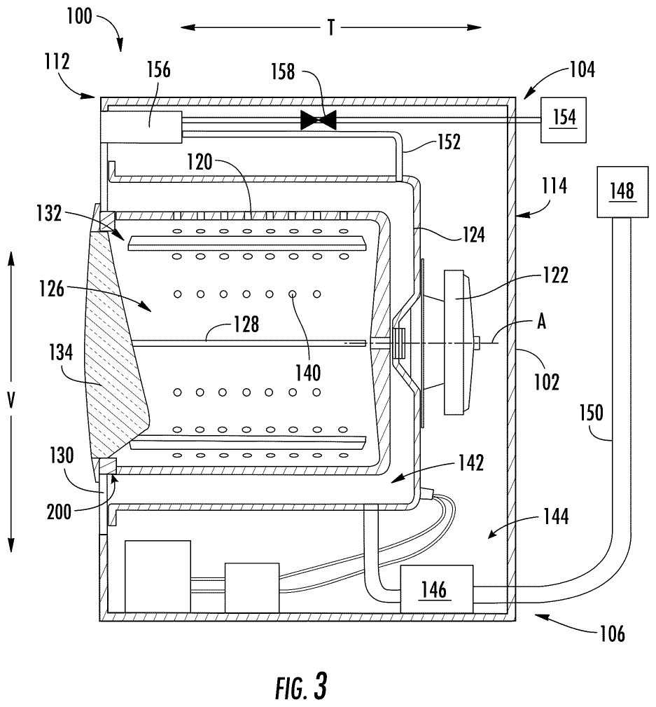

Referring now to the figures, FIG. 1 is a perspective view of an exemplary horizontal axis washing machine appliance 100, FIG. 2 is a front view of washing machine appliance 100, and FIG. 3 is a side cross-sectional view of washing machine appliance 100. As illustrated, washing machine appliance 100 generally defines a vertical direction V, a lateral direction L, and a transverse direction T, each of which is mutually perpendicular, such that an orthogonal coordinate system is generally defined. Washing machine appliance 100 includes a cabinet 102 that extends between a top 104 and a bottom 106 along the vertical direction V, between a left side 108 and a right side 110 along the lateral direction, and between a front 112 and a rear 114 along the transverse direction T.

Referring to FIGS. 2 and 3, a wash basket 120 is rotatably mounted within cabinet 102 such that it is rotatable about an axis of rotation A. A motor 122, e.g., such as a pancake motor, is in mechanical communication with wash basket 120 to selectively rotate wash basket 120 (e.g., during an agitation or a rinse cycle of washing machine appliance 100). Wash basket 120 is received within a wash tub 124 and defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. Indeed, for simplicity of discussion, these terms may all be used interchangeably herein without limiting the present subject matter to any particular “wash fluid.”

Wash basket 120 may define one or more agitator features that extend into wash chamber 126 to assist in agitation and cleaning articles disposed within wash chamber 126 during operation of washing machine appliance 100. For example, as illustrated in FIG. 3, a plurality of ribs or baffles 128 extend from basket 120 into wash chamber 126. In this manner, for example, baffles 128 may lift articles disposed in wash basket 120 during rotation of wash basket 120.

Referring generally to FIGS. 1 through 3, cabinet 102 also includes a front panel 130 which defines a chamber opening 132 that permits user access to wash basket 120 of wash tub 124. More specifically, washing machine appliance 100 includes a door 134 that is positioned over chamber opening 132 and is rotatably mounted to front panel 130. In this manner, door 134 permits selective access to chamber opening 132 by being movable between an open position (not shown) facilitating access to a wash tub 124 and a closed position (FIG. 1) prohibiting access to wash tub 124. Additionally, door 134 may be movable to numerous intermediate positions between open position and closed position, one of which is shown in FIG. 2, facilitating access to a wash tub 124.

A window 136 in door 134 permits viewing of wash basket 120 when door 134 is in the closed position, e.g., during operation of washing machine appliance 100. Door 134 also includes a handle (not labeled) that, e.g., a user may pull when opening and closing door 134. Further, although door 134 is illustrated as mounted to front panel 130, it should be appreciated that door 134 may be mounted to another side of cabinet 102 or any other suitable support according to alternative embodiments.

Referring again to FIG. 3, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 100. For example, during operation of washing machine appliance 100, wash fluid may be urged by gravity from basket 120 to sump 142 through plurality of perforations 140.

A drain pump assembly 144 is located beneath wash tub 124 and is in fluid communication with sump 142 for periodically discharging soiled wash fluid from washing machine appliance 100. Drain pump assembly 144 may generally include a drain pump 146 which is in fluid communication with sump 142 and with an external drain 148 through a drain hose 150. During a drain cycle, drain pump 146 urges a flow of wash fluid from sump 142, through drain hose 150, and to external drain 148. More specifically, drain pump 146 includes a motor (not shown) which is energized during a drain cycle such that drain pump 146 draws wash fluid from sump 142 and urges it through drain hose 150 to external drain 148.

A spout (such as supply conduit 152) may be configured for directing a flow of fluid into wash tub 124. For example, supply conduit 152 may be in fluid communication with a water supply 155 (FIG. 3) in order to direct fluid (e.g., clean water or wash fluid) into wash tub 124. Supply conduit 152 may also be in fluid communication with the sump 142. For example, pump assembly 144 may direct wash fluid disposed in sump 142 to supply conduit 152 in order to circulate wash fluid in wash tub 124.

As illustrated in FIG. 3, a dispenser drawer 156 is slidably mounted within front panel 130. Dispenser drawer 156 receives a wash additive (e.g., detergent, fabric softener, bleach, or any other suitable liquid or powder) and directs the fluid additive to wash tub 124 during operation of washing machine appliance 100. According to the illustrated embodiment, dispenser drawer 156 may also be fluidly coupled to supply conduit 152 to facilitate the complete and accurate dispensing of wash additive.

In addition, a water supply valve 158 may provide a flow of water from a water supply source (such as a municipal water supply 155) into dispenser drawer 156 and into wash tub 124. In this manner, water supply valve 158 may generally be operable to supply water into dispenser drawer 156 to generate a wash fluid, e.g., for use in a wash cycle, or a flow of fresh water, e.g., for a rinse cycle. It should be appreciated that water supply valve 158 may be positioned at any other suitable location within cabinet 102. In addition, although water supply valve 158 is described herein as regulating the flow of “wash fluid,” it should be appreciated that this term includes, water, detergent, other additives, or some mixture thereof.

A control panel 160 including a plurality of input selectors 162 is coupled to front panel 130. Control panel 160 and input selectors 162 collectively form a user interface input for operator selection of machine cycles and features. For example, in one embodiment, a display 164 indicates selected features, a countdown timer, and/or other items of interest to machine users.

Operation of washing machine appliance 100 is controlled by a controller or processing device 166 (FIG. 1) that is operatively coupled to control panel 160 for user manipulation to select washing machine cycles and features. In response to user manipulation of control panel 160, controller 166 operates the various components of washing machine appliance 100 to execute selected machine cycles and features.

Controller 166 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 160 and other components of washing machine appliance 100 may be in communication with controller 166 via one or more signal lines or shared communication busses.

During operation of washing machine appliance 100, laundry items are loaded into wash basket 120 through chamber opening 132, and washing operation is initiated through operator manipulation of input selectors 162. Wash tub 124 is filled with water, detergent, and/or other fluid additives, e.g., via supply conduit 152 and or dispenser drawer 156. One or more valves (e.g., water supply valve 158) can be controlled by washing machine appliance 100 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with baffles 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Baffles 128 may again provide agitation within wash basket 120. One or more spin cycles may also be used. In particular, a spin cycle may be applied after the wash cycle and/or after the rinse cycle in order to wring wash fluid from the articles being washed. During a final spin cycle, basket 120 is rotated at relatively high speeds and drain pump assembly 144 may discharge wash fluid from sump 142. After articles disposed in wash basket 120 are cleaned, washed, and/or rinsed, the user can remove the articles from wash basket 120, e.g., by opening door 134 and reaching into wash basket 120 through chamber opening 132.

While described in the context of a specific embodiment of horizontal axis washing machine appliance 100, using the teachings disclosed herein it will be understood that horizontal axis washing machine appliance 100 is provided by way of example only. Other washing machine appliances having different configurations, different appearances, and/or different features may also be utilized with the present subject matter as well, e.g., vertical axis washing machine appliances.

Referring still to FIG. 1, a schematic diagram of an external communication system 170 will be described according to an exemplary embodiment of the present subject matter. In general, external communication system 170 is configured for permitting interaction, data transfer, and other communications between washing machine appliance 100 and one or more external devices. For example, this communication may be used to provide and receive operating parameters, user instructions or notifications, performance characteristics, user preferences, or any other suitable information for improved performance of washing machine appliance 100. In addition, it should be appreciated that external communication system 170 may be used to transfer data or other information to improve performance of one or more external devices or appliances and/or improve user interaction with such devices.

For example, external communication system 170 permits controller 166 of washing machine appliance 100 to communicate with a separate device external to washing machine appliance 100, referred to generally herein as an external device 172. As described in more detail below, these communications may be facilitated using a wired or wireless connection, such as via a network 174. In general, external device 172 may be any suitable device separate from washing machine appliance 100 that is configured to provide and/or receive communications, information, data, or commands from a user. In this regard, external device 172 may be, for example, a personal phone, a smartphone, a tablet, a laptop or personal computer, a wearable device, a smart home system, or another mobile or remote device.

In addition, a remote server 176 may be in communication with washing machine appliance 100 and/or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control washing machine appliance 100, etc. In addition, external device 172 and remote server 176 may communicate with washing machine appliance 100 to communicate similar information.

In general, communication between washing machine appliance 100, external device 172, remote server 176, and/or other user devices or appliances may be carried using any type of wired or wireless connection and using any suitable type of communication network, non-limiting examples of which are provided below. For example, external device 172 may be in direct or indirect communication with washing machine appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

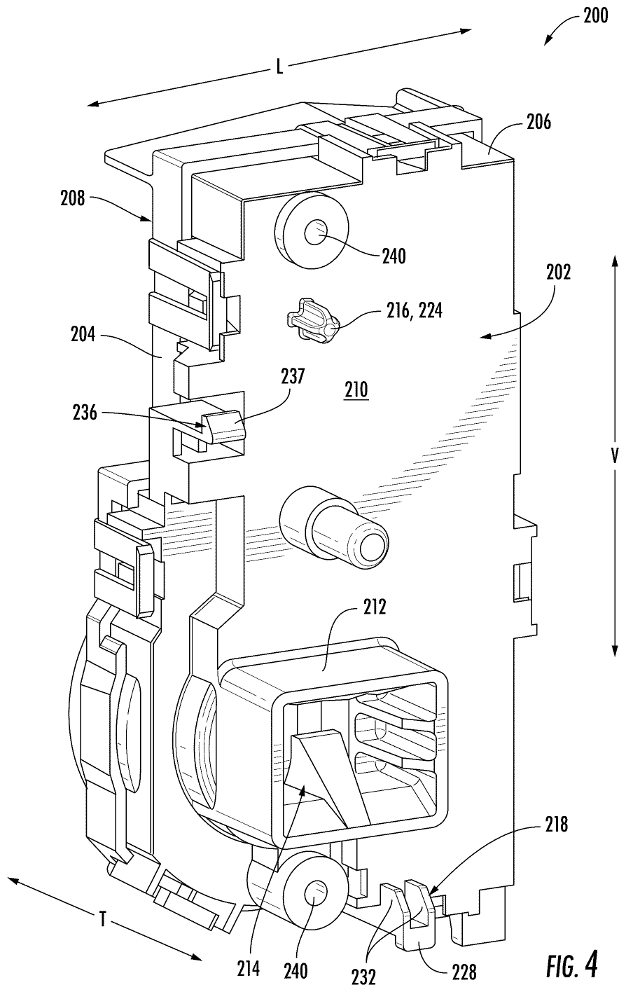

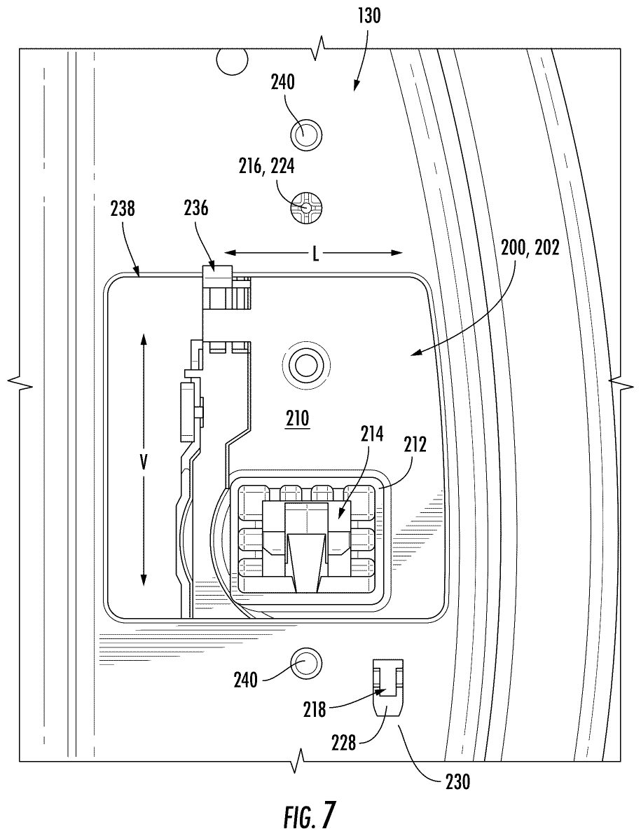

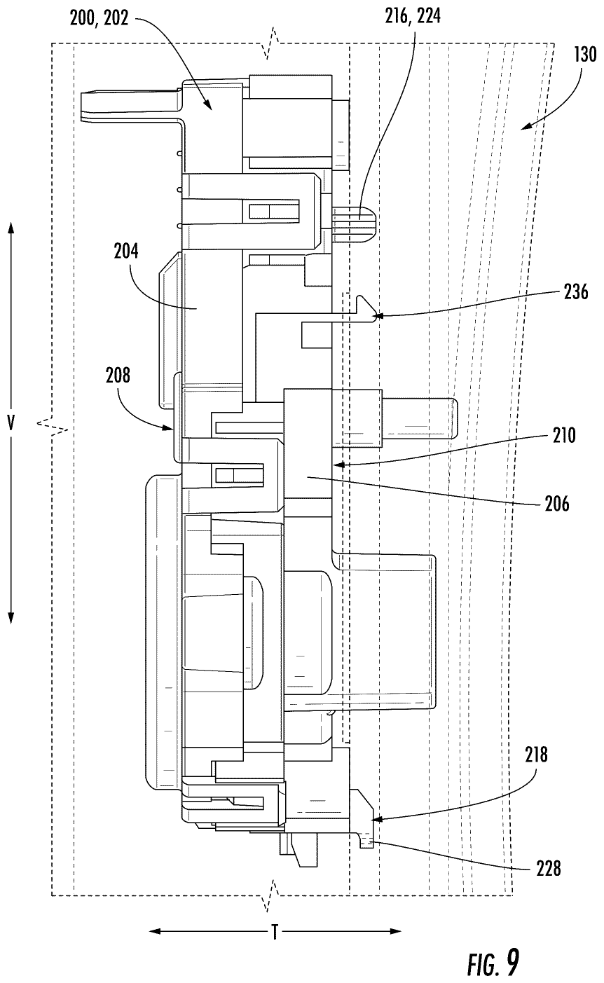

Referring now generally to FIGS. 4 through 11, a door lock assembly 200 that may be used with washing machine appliance 100 will be described according to example embodiments of the present subject matter. Although door lock assembly 200 is described herein as being used with washing machine appliance 100, it should be appreciated that door lock assembly 200 may be used on any other suitable laundry appliance, e.g., such as a dryer appliance, a combination washer/dryer appliance, or any other suitable appliance to provide selective access to an interior chamber through an opening, such as a front opening. Additionally, although door lock assembly 200 is described herein as being mounted to front panel 130 of washing machine appliance 100, it should be appreciated that door lock assembly 200 may be mounted to any other suitable panel of washing machine appliance 100, such as to a top panel (not shown), or to any suitable panel of any other suitable laundry appliance. Although an exemplary construction of door lock assembly 200 is described herein, it should be appreciated that variations and modifications may be made to door lock assembly 200 while remaining within the scope of the present subject matter.

According to example embodiments, door lock assembly 200 may include a door lock main body or frame 202 for housing and/or supporting various components of door lock assembly 200. Door lock frame 202 may include an inner door lock frame 204 attached or coupled to an outer door lock frame 206. In this respect, inner door lock frame 204 and outer door lock frame 206 may be detached from each other to expose an interior (not shown) of door lock frame 202, which may house various components used to selectively lock door 134.

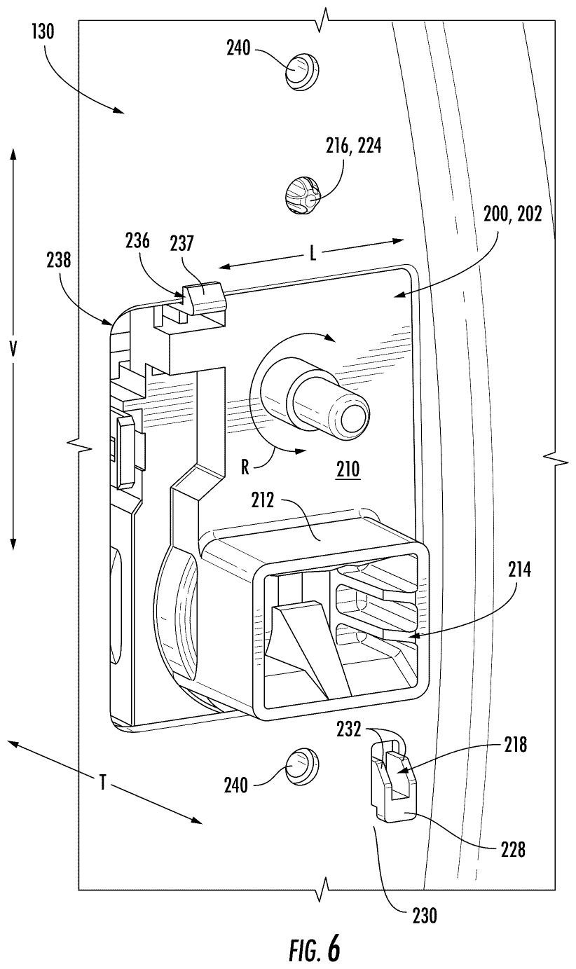

According to example embodiments, inner dock lock frame 204 may include an inner side 208 of door lock frame 202 and outer door lock frame 206 may include an outer side 210 of door lock frame 202. As shown in FIG. 6, outer side 210 of door lock frame 202 may be closer to the panel of the cabinet to which door lock assembly 200 is mounted, such as, for example, front panel 130. In this respect, outer side 210 of door lock frame 202 may be closer to front panel 130 than inner side 208 of door lock frame 202. Additionally, outer side 210 and inner side 208 of door lock frame 202 may be spaced apart from each other, such as in transverse direction T, and may face in opposite directions from each other, e.g., when mounted to front panel 130, outer side 210 may face forwards while inner side 208 faces backwards.

According to example embodiments, door lock assembly 200 defines a door lock receptacle 212 extending from outer side 210 of door lock frame 202. Door lock receptacle 212 may extend from outer side 210 of door lock frame 202 in transverse direction T. A receptacle interior 214 of door lock receptacle 212 may be configured and sized to receive a striker (not shown) of door 134 therein for closing door 134 of washing machine appliance 100. Additionally, a latch (not shown) and/or various other components may be housed within receptacle interior 214 for engaging the striker and thereby locking door 134 when door 134 is moved to the closed position from the open position or a partially open intermediate position.

Notably, as briefly described above, door strikers and door lock receptacles on conventional washing machine appliances (or laundry appliances in general) sometimes become misaligned. Striker and door lock misalignment may be due to shifting/movement of the door lock or due to variation in the assembly of the laundry appliance. This may result in the inability to close and/or lock the door, operational issues, and/or user dissatisfaction, such as unsatisfactory door feel. Accordingly, aspects of the present subject matter are directed to door lock assembly 200 with improved positioning features for alignment and attachment. Although an exemplary construction is described herein, it should be appreciated that variations and modifications may be made while remaining within the scope of the present subject matter.

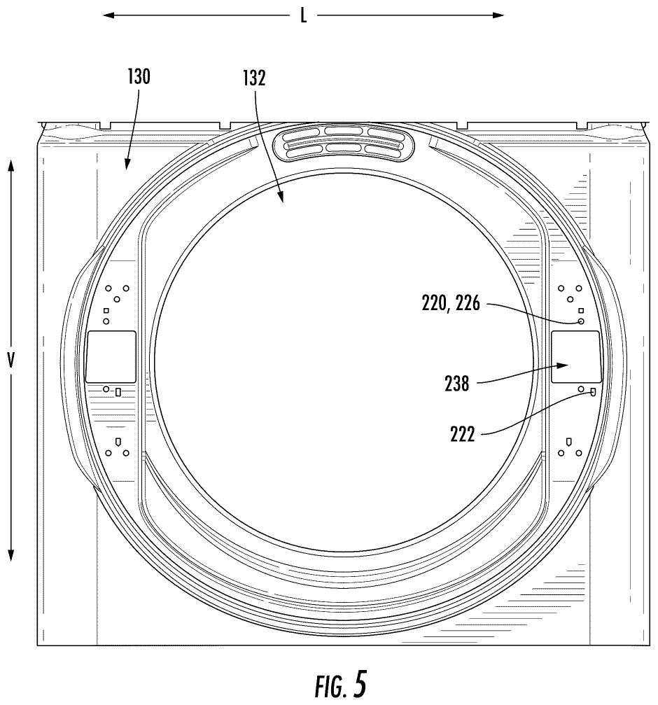

According to example embodiments, door lock assembly 200 is mounted to one of the panels of cabinet 102 of washing machine appliance 100. As such, door lock frame 202 of door lock assembly 200 defines a first positioning feature 216 and a second positioning feature 218 that extend from a side of door lock frame 202, such as outer side 210. The first positioning feature 216 and second positioning feature 218 locate/align and may mount door lock frame 202 to one of the panels of cabinet 102, such as to front panel 130, and inhibit relative movement between door lock frame 202 and front panel 130. Furthermore, first positioning feature 216 and second positioning feature 218 position door lock frame 202 relative to the striker of door 134. In this respect, front panel 130, or other panel of cabinet 102 to which door lock assembly 200 is mounted, may define a first positioning feature aperture 220 (FIGS. 5, 10-11) therethrough for receiving first positioning feature 216. Similarly, front panel 130 may define a second positioning feature aperture 222 (FIGS. 5, 10-11) therethrough for receiving second positioning feature 218. As shown in FIG. 5, in some embodiments, first positioning feature aperture 220 and second positioning feature aperture 222 may be defined through front panel 130 for a left-hand mounted and rotating door 134. In this respect, first positioning feature aperture 220 and second positioning feature aperture 222 may be defined through front panel 130 to the right of chamber opening 132 in lateral direction L. However, it should be appreciated that, in other embodiments, first positioning feature aperture 220 and second positioning feature aperture 222 may be defined through front panel 130 for a right-hand mounted and rotating door 134. In this respect, first positioning feature aperture 220 and second positioning feature aperture 222 may be defined through front panel 130 to the left of chamber opening 132 in lateral direction L.

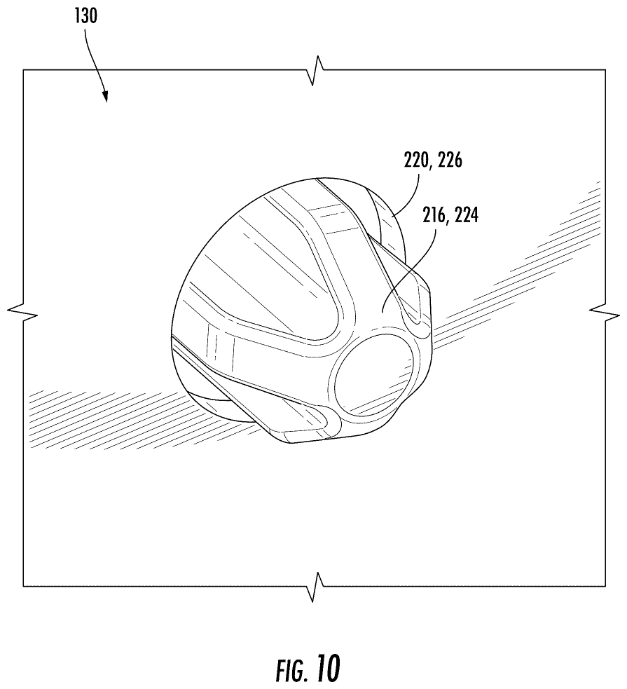

According to example embodiments, when door lock frame 202 is mounted to front panel 130 of cabinet 102, first positioning feature 216 engages first positioning feature aperture 220 to constrain or inhibit relative movement between door lock frame 202 and front panel 130. First positioning feature 216 may engage first positioning feature aperture 220 to constrain or inhibit relative movement between door lock frame 202 and front panel 130 in one or more directions, such as two directions within the same plane or any combination of the two directions. For example, first positioning feature 216 may engage first positioning feature aperture 220 to constrain or inhibit relative movement between door lock frame 202 and front panel 130 in vertical direction V and lateral direction L and any combination of vertical direction V and lateral direction L, e.g., in a vertical-lateral plane defined by the vertical direction V and the lateral direction L. In this respect, as best illustrated in FIG. 10, first positioning feature 216 may be configured as a cylindrical or circular pin 224 and first positioning feature aperture 220 may correspond to a circular aperture 226 with a diameter greater than, but substantially similar to, a diameter of the circular pin 224. In this respect, circular aperture 226 may receive circular pin 224 therethrough and bound circular pin 224 to constrain or inhibit relative movement between front panel 130 and door lock frame 202 in multiple directions. For example, circular pin 224 may extend from door lock frame 202 and be received through circular aperture 226 in transverse direction T. Circular aperture 226 may surround and bound circular pin 224 such that movement of door lock frame 202 relative to front panel 130 is constrained or inhibited in vertical direction V, lateral direction L, and any combination thereof.

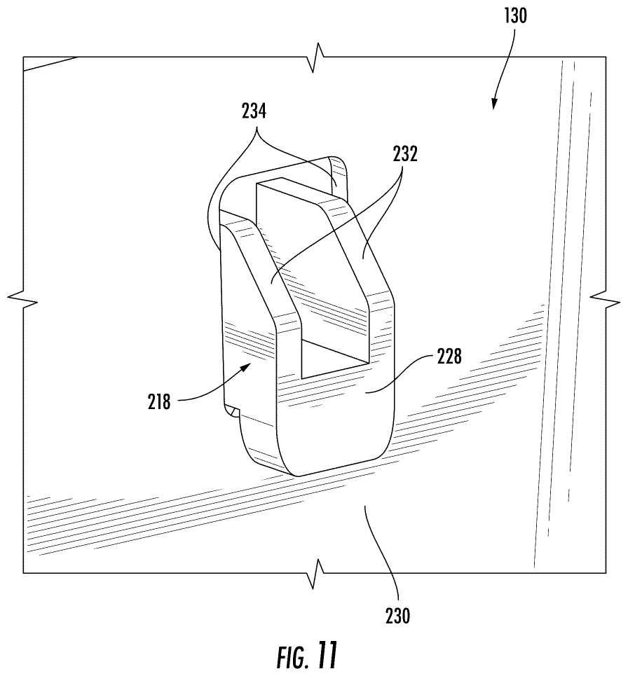

According to example embodiments, in addition to first positioning feature 216 engaging first positioning feature aperture 220 when door lock frame 202 is mounted to front panel 130 of cabinet 102, second positioning feature 218 engages second positioning feature aperture 222 to constrain or inhibit relative movement between door lock frame 202 and front panel 130. Second positioning feature 218 may engage second positioning feature aperture 222 to constrain or inhibit relative movement between door lock frame 202 and front panel 130 in one or more directions, such as one direction. For example, second positioning feature 218 may engage second positioning feature aperture 222 to constrain or inhibit relative movement between door lock frame 202 and front panel 130 in transverse direction T. In this respect, as best illustrated in FIG. 11, second positioning feature 218 may include a hook portion 228 that is received through second positioning feature aperture 222. Second positioning feature aperture 222 may be elongated in a direction, such as in vertical direction V. In this respect, when mounting door lock frame 202 to front panel 130, second positioning feature 218 may be moved within and along second positioning feature aperture 222 in the direction in which second positioning feature aperture 222 is elongated (e.g., vertical direction), such that hook portion 228 of second positioning feature 218 is positioned over an outer surface 230 of front panel 130. When hook portion 228 of second positioning feature 218 is positioned over outer surface 230 of front panel 130, relative movement between door lock frame 202 and front panel 130 is inhibited in transverse direction T.

Additionally, in some embodiments, second positioning feature 218 may engage second positioning feature aperture 222 to constrain or inhibit relative movement between door lock frame 202 and front panel 130 in two directions in the same plane. For example, second positioning feature 218 may engage second positioning feature aperture 222 to constrain or inhibit relative movement between door lock frame 202 and front panel 130 in transverse direction T and lateral direction L. In this respect, hook portion 228 of second positioning feature 218 may also include one or more hook portion walls 232 received through second positioning feature aperture 222. Second positioning feature aperture 222 may be surrounded by a pair of aperture walls 234 spaced apart from each other with the second positioning feature aperture 222 positioned between pair of aperture walls 234. When second positioning feature 218 is received through second positioning feature aperture 222, hook portion wall(s) 232 may be received between pair of aperture walls 234. The spacing between pair of aperture walls 234 may be greater than, but substantially similar to, a width or spacing of hook portion wall(s) 232. In this respect, second positioning feature aperture 222 may bound second positioning feature 218 to constrain or inhibit relative movement between front panel 130 and door lock frame 202 in lateral direction L.

According to example embodiments, in addition to constraining and inhibiting relative movement between door lock frame 202 and front panel 130 in the manner described above, first positioning feature 216 and second positioning feature 218 engage first positioning feature aperture 220 and second positioning feature aperture 222 respectively to collectively constrain or inhibit relative rotational movement between door lock frame 202 and front panel 130. For example, when circular pin 224 is received through and bounded by circular aperture 226 and hook portion 228 of second positioning feature 218 is received through second positioning feature aperture 222, rotation of door lock frame 202 in a rotational direction R (FIG. 6) relative to front panel 130 is constrained or inhibited. As such, when hook portion 228 of second positioning feature 218 is received through second positioning feature aperture 222, hook portion wall(s) 232 are constrained by pair of aperture walls 234 such that rotation of door lock frame 202 in rotational direction R relative to front panel 130 is constrained or inhibited.

In some embodiments, door lock frame 202 of door lock assembly 200 defines a third positioning feature 236 that extends from a side of door lock frame 202, such as outer side 210. Third positioning feature 236 aids first positioning feature 216 and second positioning feature 218 in mounting door lock frame 202 to one of the panels of cabinet 102, such as to front panel 130, and constraining or inhibiting relative movement between door lock frame 202 and front panel 130. In this respect, front panel 130, or other panel of cabinet 102 to which door lock assembly 200 is mounted, may define a third positioning feature aperture 238 (FIGS. 5-8) therethrough for receiving third positioning feature 236. Third positioning feature 236 engages third positioning feature aperture 238 to constrain or inhibit relative movement between door lock frame 202 and front panel 130. Third positioning feature 236 may engage third positioning feature aperture 238 to constrain or inhibit relative movement between door lock frame 202 and front panel 130 in one or more directions, such as one direction. For example, third positioning feature 236 may engage third positioning feature aperture 238 to constrain or inhibit relative movement between door lock frame 202 and front panel 130 in transverse direction T. In this respect, third positioning feature 236 may also include hook portion 237, which is received through third positioning feature aperture 238. When mounting door lock frame 202 to front panel 130, third positioning feature 236 may be moved within third positioning feature aperture 238 such that hook portion 237 of third positioning feature 236 is positioned over outer surface 230 of front panel 130. When hook portion 237 of third positioning feature 236 is positioned over outer surface 230 of front panel 130, relative movement between door lock frame 202 and front panel 130 is inhibited in transverse direction T. Additionally, in some embodiments, it should be appreciated that third positioning feature aperture 238 may correspond to a receptacle opening through which door lock receptacle 212 is also received/extends through to receive the striker of door 134 when door 134 is closed.

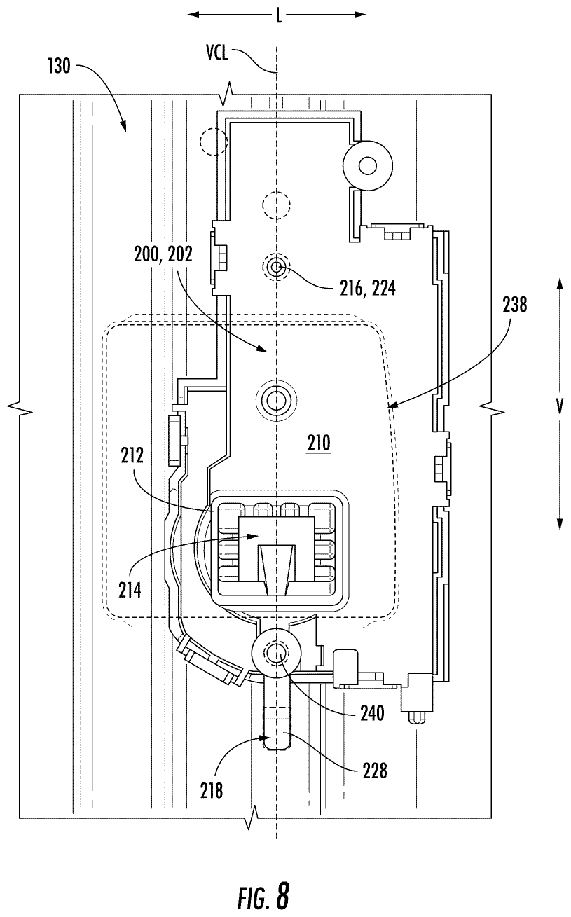

Moreover, in some embodiments, first positioning feature 216 and second positioning feature 218 are aligned in vertical direction V, lateral direction L, or transverse direction T to inhibit relative movement between door lock frame 202 and the corresponding panel to which door lock frame 202 is mounted. For example, as best illustrated in FIG. 8, when door lock frame 202 is mounted to front panel 130, first positioning feature 216 and second positioning feature 218 and, likewise, first positioning feature aperture 220 and second positioning feature aperture 222, are aligned in vertical direction V as indicated by vertical centerline VCL. However, it should be appreciated that in other embodiments, such as when door lock frame 202 is mounted to a different panel, that first positioning feature 216 and second positioning feature 218 may be aligned in a different direction. Furthermore, as best illustrated in FIG. 8, it should be appreciated that in some embodiments, door lock frame 202 of door lock assembly 200 does not define third positioning feature 236 when first positioning feature 216 and second positioning feature 218 are aligned in vertical direction V, lateral direction L, or transverse direction T. However, it should also be appreciated that, in some other embodiments, door lock frame 202 of door lock assembly 200 defines third positioning feature 236 when first positioning feature 216 and second positioning feature 218 are aligned in vertical direction V, lateral direction L, or transverse direction T.

Although positioning features 216, 218, 236 are illustrated and described herein as being a cylindrical or circular pin and including hook portions respectively, it should be appreciated that positioning features may alternatively refer to any protrusion or feature having any suitable size, geometry, or configuration, such as tabs, cones, or any other suitable protruding locating features.

According to example embodiments, door lock assembly 200 may further include a plurality of mechanical fasteners (not shown), e.g., such as mechanical screws, that are used to attach door lock frame 202 to front panel 130 of cabinet 102 of washing machine appliance 100. In this regard, door lock frame 202 may define a plurality of screw bosses 240 that are configured to securely receive mechanical fasteners. Accordingly, by passing mechanical fasteners through front panel 130 and into screw bosses 240, the relative movement between door lock frame 202 and front panel 130 may be further restrained. Accordingly, once mechanical fasteners are installed, relative motion between these components may be further restrained in all degrees of freedom. According to the illustrated embodiment, door lock frame 202 may define screw bosses 240 adjacent to each of first positioning feature 216 and second positioning feature 218, though other positioning may be used while remaining within the scope of the present subject matter.

As explained herein, aspects of the present subject matter are generally directed to a door lock assembly for a laundry appliance that be located and assembled to a panel, such as the front panel, of the laundry appliance with two or more positioning features. The positioning features may be received through positioning feature apertures to constrain or inhibit relative movement between the door lock frame and panel in various directions such that alignment of the door lock receptacle with the striker of the door of the laundry appliance is maintained. For example, one or more of these positioning features may be configured as a circular pin and one or more other positioning features may include a hook portion to be positioned over the panel.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A laundry appliance defining a vertical direction, a transverse direction, and a lateral direction, the laundry appliance comprising:
a cabinet comprising a panel;
a basket rotatably mounted within the cabinet and defining a chamber for receiving of a load of clothes;
a door rotatably mounted to the cabinet to provide selective access to the chamber; and
a door lock assembly mounted to the panel for selectively locking the door, the door lock assembly comprising:
a door lock frame defining a first positioning feature and a second positioning feature that extend from the door lock frame,
wherein:
the panel of the cabinet defines a first positioning feature aperture and a second positioning feature aperture; and
the first positioning feature aperture is configured to receive the first positioning feature and the second positioning feature aperture is elongated in the vertical direction, the transverse direction, or the lateral direction and configured to receive the second positioning feature.

2. The laundry appliance of claim 1, wherein:
the second positioning feature engages the second positioning feature aperture to thereby inhibit relative movement between the door lock frame and the panel of the cabinet in the lateral direction, the vertical direction, the transverse direction, or a rotational direction.

3. The laundry appliance of claim 1, wherein:
the second positioning feature engages the second positioning feature aperture to thereby inhibit relative movement between the door lock frame and the panel of the cabinet in two directions; and
the two directions correspond to two of the lateral direction, the vertical direction, the transverse direction, or a rotational direction.

4. The laundry appliance of claim 3, wherein:
the second positioning feature includes a hook portion; and
when the second positioning feature engages the second positioning feature aperture, the hook portion is received through the second positioning feature aperture and over an outer surface of the panel to thereby inhibit relative movement between the door lock frame and the panel of the cabinet in the two directions.

5. The laundry appliance of claim 1, wherein:
the first positioning feature aperture is circular;
the first positioning feature engages the first positioning feature aperture to thereby inhibit relative movement between the door lock frame and the panel of the cabinet in two directions; and
the two directions correspond to two of the lateral direction, the vertical direction, or the transverse direction.

6. The laundry appliance of claim 1, wherein:
the door lock frame defines a third positioning feature; and
the panel of the cabinet defines a third positioning feature aperture, the third positioning feature aperture configured to receive the third positioning feature.

7. The laundry appliance of claim 6, wherein:
the third positioning feature engages the third positioning feature aperture to thereby inhibit relative movement between the door lock frame and the panel of the cabinet in the lateral direction, the vertical direction, the transverse direction, or a rotational direction.

8. The laundry appliance of claim 1, wherein:
the door lock frame defines a first screw boss positioned adjacent the first positioning feature and a second screw boss positioned adjacent the second positioning feature for receiving mechanical fasteners therein.

9. The laundry appliance of claim 1, wherein:
the first positioning feature and the second positioning feature are aligned in the lateral direction, the vertical direction, or the transverse direction.

10. The laundry appliance of claim 1, wherein:
the panel of the cabinet is configured as a front panel of the cabinet.

11. The laundry appliance of claim 1, wherein the laundry appliance is a front load washing machine appliance or a front load dryer appliance.

12. A laundry appliance defining a vertical direction, a transverse direction, and a lateral direction, the laundry appliance comprising:
a cabinet comprising a panel;
a tub positioned within the cabinet;
a basket rotatably mounted within the tub and defining a chamber for receiving of a load of clothes;
a door rotatably mounted to the cabinet to provide selective access to the chamber; and
a door lock assembly mounted to the panel for selectively locking the door, the door lock assembly comprising:
a door lock frame defining a first positioning feature and a second positioning feature that extend from the door lock frame, the second positioning feature including a hook portion,
wherein:
the panel of the cabinet defines a first positioning feature aperture and a second positioning feature aperture;
the first positioning feature aperture is circular; and
the first positioning feature aperture is configured to receive the first positioning feature and the second positioning feature aperture is configured to receive the second positioning feature.

13. The laundry appliance of claim 12, wherein:
the second positioning feature aperture is elongated in the vertical direction, the transverse direction, or the lateral direction; and
the second positioning feature engages the second positioning feature aperture to thereby inhibit relative movement between the door lock frame and the panel of the cabinet in the lateral direction, the vertical direction, the transverse direction, or a rotational direction.

14. The laundry appliance of claim 12, wherein:
the hook portion is received through the second positioning feature aperture and over an outer surface of the panel to thereby inhibit relative movement between the door lock frame and the panel of the cabinet in the lateral direction, the vertical direction, the transverse direction, or a rotational direction.

15. The laundry appliance of claim 12, wherein:
the first positioning feature engages the first positioning feature aperture to thereby inhibit relative movement between the door lock frame and the panel of the cabinet in two directions; and
the two directions correspond to two of the lateral direction, the vertical direction, or the transverse direction.

16. The laundry appliance of claim 12, wherein:
the door lock frame defines a third positioning feature; and
the panel of the cabinet defines a third positioning feature aperture, the third positioning feature aperture configured to receive the third positioning feature.

17. The laundry appliance of claim 16, wherein:
the third positioning feature engages the third positioning feature aperture to thereby inhibit relative movement between the door lock frame and the panel of the cabinet in the lateral direction, the vertical direction, the transverse direction, or a rotational direction.
